(19) United States
(12) Patent Application Publication
(10) Pub. No.: US 2009/0063942 A1
(43) Pub. Date: Mar. 5, 2009

(54) SYSTEM AND METHOD FOR ASSOCIATING A REPORT WITH A CUSTOMIZABLE TEMPLATE

(76) Inventor: Raphael Frederick Laderman, Hayward, CA (US)

Correspondence Address: KEVIN J. MACK, 112 MAPLE LN, E. PALO ALTO, CA, 94303, US

(21) Appl. No.: 11/840,185

(22) Filed: Aug. 30, 2007

(51) Int. Cl. G06F 17/00

(52) U.S. Cl. 715/200; 715/234

(57) ABSTRACT

A system and method for associating a report with a customizable template is disclosed. In some embodiments, the system comprises a first data source that stores a plurality of customizable templates, a second data source that stores a plurality of reports, and logic coupled to the first and second data sources and configured to associate at least one of the plurality of reports with at least one of the plurality of customizable templates.

### FIELD OF THE INVENTION

The invention relates generally to systems and methods for generating content, and more particularly, to associating two or more types of content together.

### BACKGROUND

Acquiring new customers and clients is essential in almost every profession. For example, attorneys, doctors, and real estate and insurance brokers all require an influx of new clients to thrive. Generally, these professionals utilize marketing and advertising to reach out to prospective customers. For example, an attorney may advertise his services in a newspaper, magazine, or telephone directory in hopes that prospective clients will contact him. Similarly, a real estate broker may purchase a list of individuals who presumably are looking to buy or sell property. The broker may then contact each individual on the list to inquire if his services are needed.

Each of these advertising techniques, however, suffers from several shortcomings. First, the techniques offer a low return on investment. For example, an insurance broker may purchase a list of leads for thousands of dollars and obtain new clients worth only hundreds of dollars. Second, these traditional advertising techniques are time consuming. Generally, the professional must carefully design his advertisement and then perform market research to pinpoint when and where to broadcast the advertisement. Third, prospective clients may be exposed to a wealth of advertising material from direct competitors, thereby reducing the likelihood that the prospective client will actually call any given advertiser. Thus, what is needed is a system and method for distributing content to prospective clients that is not only cost effective but also stands out from other forms of advertising.

### BRIEF SUMMARY

A system and method for associating a report with a customizable template is disclosed. In some embodiments, the system comprises a first data source that stores a plurality of customizable templates, a second data source that stores a plurality of reports, and logic coupled to the first and second data sources and configured to associate at least one of the plurality of reports with at least one of the plurality of customizable templates. In accordance with other embodiments, the method comprises selecting one of a plurality of layouts, personalizing the selected layouts, selecting one of a plurality of articles, associating the selected article with the selected layout, and automatically creating visual content containing the selected article and the selected layout.

### BRIEF DESCRIPTION OF THE DRAWINGS

For a detailed description of exemplary embodiments of the invention, reference will now be made to the accompanying drawings in which:

FIG. 1 illustrates a system constructed in accordance with embodiments of the invention;

FIG. 2 depicts a framework configured in accordance with embodiments of the invention and used to query the heterogeneous data sources of FIG. 1; and

FIG. 3 shows an exemplary fragment of a thesaurus in accordance with embodiments of the invention;

### NOTATION AND NOMENCLATURE

In the following discussion and in the claims, the terms “including” and “comprising” are used in an open-ended fashion, and thus should be interpreted to mean “including, but not limited to”. Also, the term “couple, “couples,” or “coupled” is intended to mean either an indirect or direct electrical or communicative connection. Thus, if a first device couples to a second device, that connection may be through a direct connection, or through an indirect connection via other devices and connections.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

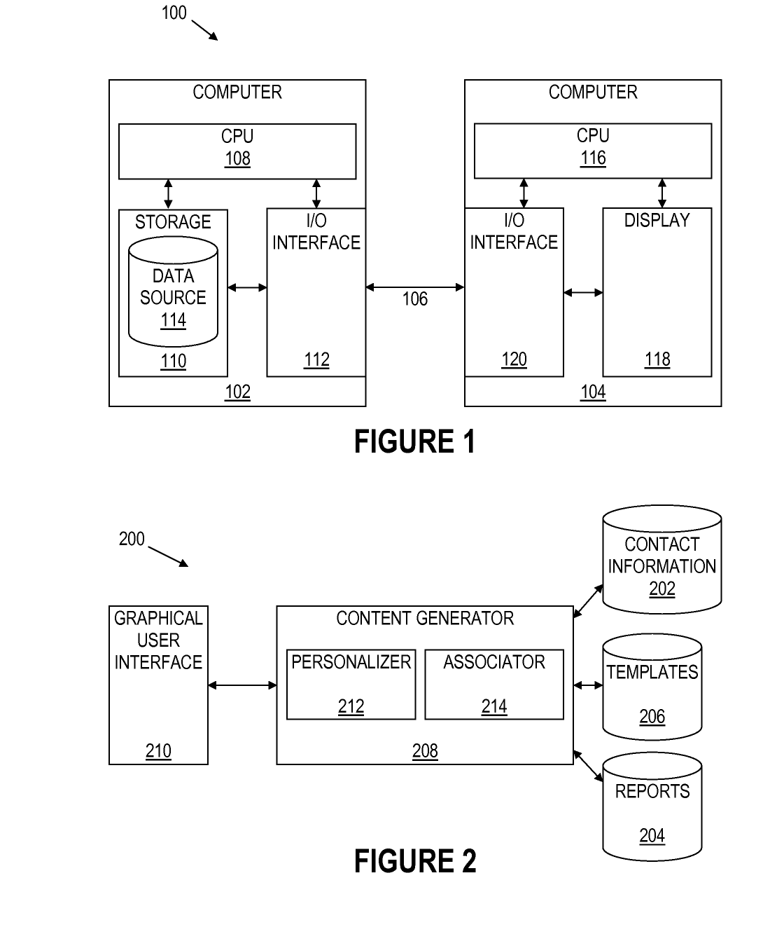

FIG. 1 illustrates a system 100 constructed in accordance with embodiments of the invention. System 100 comprises a plurality of computers 102 and 104 coupled together through a communications channel 106. The computers 102 and 104 may represent any type of computer system, such as a laptop computer, a personal computer, or a stand-alone computer operated as a server. The communications channel 106 may represent any type of computer network, such as the Internet, a local area network (LAN), and a wide area network (WAN), or any other type of communications link created through wire-line or wireless technologies, such as Bluetooth, Infrared, Ethernet, and Fiber Channel.

As illustrated in FIG. 1, the computer 102 comprises a central processing unit (CPU) 108, a storage 110, and an Input/Output (I/O) interface 112 coupled together. The storage 110 represents any type of volatile and/or non-volatile memory, such as random access memory (RAM) and read only memory (ROM), or any other medium for storing information, such as a hard drive, universal serial bus (USB) flash drive, memory stick, cell phone, and iPod®. The storage 110 comprises a data source 114. The data source 114 may represent a database, a flat-file, an XML file, or any other type of data repository, such as a partition on a DVD or CD-ROM. In addition, the data source 114 may represent a single physical unit that contains multiple sources of data. For example, the data source 114 may represent a relational database that contains information from a variety of sources, such as newspapers, magazines, and technical manuals.

The computer 104 comprises a CPU 116, a display 118, and an I/O interface 120 coupled together. The display 118 represents any device for portraying visual information, such as a monitor, television, and projector. The computers 102 and 104 may comprise the single CPUs 108 and 116 respectively, or may comprise a plurality of CPUs arranged in a configuration where parallel computing may take place. Although only two computers and one data source are illustrated in FIG. 1, any number of computers and data sources may be used as desired.

FIG. 2 depicts a framework 200 configured in accordance with embodiments of the invention. As illustrated in FIG. 2, the framework 200 comprises a repository of contact information 202, a repository of reports 204, a repository of templates 206, a content generator 208, and a graphical user interface (GUI) 210. The content generator 208 compromises a personalizer 212 and an associator 214. The GUI 210 may interact with the content generator 208 and utilize the contact information 202, the reports 204, and templates 206 to create personalized promotional content, such as flyers, post cards, and new letters. The content generator 208 may be implemented in software, hardware, or a combination thereof. For example, the content generator 208 may represent a web application written in any suitable programming language, such as PHP, Perl and Ruby.

The personalizer 212 preferably utilizes the templates 206 to customize content based on a user's preferences. The templates 206 represent predefined layouts that have been specifically designed to increase the visibility of the content or to increase the probability of influencing a viewer of the content. In at least some embodiments, the personalizer 212 allows users to upload, edit, or other modify content, such as still images, video, and text. For example, the personalizer 212 may enable a user to upload an image of a product or service they are offering. The personalizer 212 may also allow the user to crop, resize, mix, or otherwise integrate the uploaded content with the templates 206. The templates 206 are preferable customizable themselves, in that the user may change various physical attributes associated with the templates, such as color scheme, background and foreground color, font size, text message, text orientation, and positioning of graphical elements.

The associator 214 preferably utilizes the reports 204 to integrate a description of a report to one or more of the templates 206. The reports 204 represent prewritten articles, market analyses, and reports that are design to influence a viewer of the content. For example, the associator 214 may associate an insider report that discusses real estate related topics for a particular area of the country. The associator 214 would link the insider report to a template by automatically adding text, images, or video to the template indicating the availability of the report. Generally, the report would act as an incentive for the viewer to contact the creator of the content, but at least in some embodiments, the reports may be offered for a fee. Although a real estate report was used in the preceding example, any type of prewritten content may be utilized as desired, such as information related to insurance, banking, mortgages, travel, as well as a variety of consumer and business products, such as automobiles, televisions, and computers.

As can be appreciated, the system 100 and framework 200 provide a flexible and scalable means of generating and associating content. Although the contact information 202, the reports 204, and the templates 204 are show as discrete data sources in FIG. 2, they may be combined into a single data source if desired. In addition, although a graphical user interface is shown in FIG. 2, any type of user interface may be employed, such as a command line interface, a virtual interface, an auditory interface, and a haptic interface.

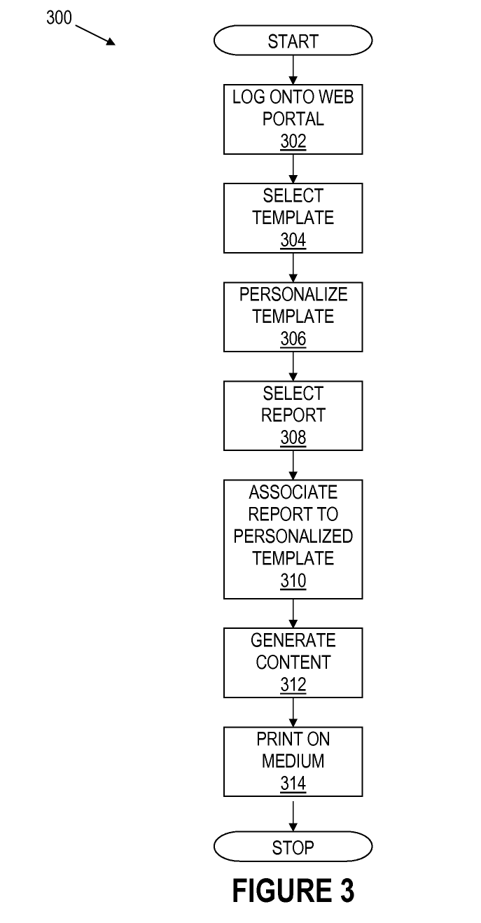

FIG. 3 illustrates an exemplary method of associating and generating content in accordance with embodiments of the invention. The method 300 starts when a user logs onto a web portal (302). The user then selects one or more templates from a databank of templates (304). As previously discussed, the templates are preferably designed to be eye-catching and influence viewers of content generated with the template. After selecting a template, the user personalizes the template (306). This personalization may include editing predefined text, selecting a color scheme, changing the orientation of text, adding images and video, or any other customization that changes the appearance of the template. The user then selects one or more reports (308). As previously discussed, the reports represent any prewritten content, such as marketing articles, analysis, and reports. The selected reports are then associated with the personalized template (310). This association process may include the creation of text, images, video, or any other visual element that is designed to link the personalized template to the report. For example, the association process may entail creating text offering the report for free as an incentive to call the user. Content is then automatically generated that contains the personalized template and the report, however associated (312). The process ends after the content is printed onto a medium (314). The medium may include a postcard, a letter, an email, or any other type of medium that portrays visual content, such as a Multimedia Messaging Service (MMS) message or Short Message Service (SMS) text message. Various steps may be added, removed, or reordered as desired. For example, contact information for an individual may also be associated to the content. This contact information may represent the mailing address of the individual intended to receive that the content. Thus, when the content in printed on the medium, it is ready to be mailed. Similarly, electronic postage may similarly be associated with the content.

The above discussion is meant to be illustrative of the principles and various embodiments of the present invention. Numerous variations and modifications will become apparent to those skilled in the art once the above disclosure is fully appreciated. For example, in embodiments employing the Internet, the reports may be accessible by the viewer of the content through a Uniform Resource Identifier (URI). Thus, if a viewer wants access to the report, the viewer may simply click on a hyperlink and be presented with the report and additional information, such as coupons, from the creator of the content. In addition, users may interact with the system through various wireless devices, such as cell phones, personal digital assistant (PDAs), and pockets PCs. A user of a wireless device may select a template, personalize the template, and/or select a report, through the wireless devices. It is intended that the following claims be interpreted to embrace all such variations and modifications.

What is claimed is:

1. A system, comprising:
a first data source that stores a plurality of customizable templates;
a second data source that stores a plurality of reports; and
logic coupled to the first and second data sources and configured to associate at least one of the plurality of reports with at least one of the plurality of customizable templates.

2. The system of claim 1 wherein the plurality of customizable templates comprises preformatted designs for promotional content.

3. The system of claim 1 wherein the plurality of reports comprises prewritten marketing information for an industry selected from the group consisting of real estate, insurance, and mortgage.

4. The system of claim 1 wherein the logic is further configured to automatically generate visual content containing at least one of the plurality of reports and at least one of the plurality of customizable templates.

5. The system of claim 1 further comprising a third data source that stores contact information for a plurality of individuals.

6. The system of claim 5 wherein the logic is further configured to automatically generate visual content containing at least one of the plurality of reports, at least one of the plurality of customizable templates, and contact information from at least one of the plurality of individuals.

7. The system of claim 6 wherein the plurality of individuals comprise prospective clients of a user of the system.

8. A method, comprising:
selecting one of a plurality of layouts;
personalizing the selected layout;
selecting one of a plurality of articles;
associating the selected article with the selected layout; and
automatically creating visual content containing the selected article and the selected layout.

9. The method of claim 8 wherein personalizing the selected layout comprises selecting a color scheme and applying the color scheme to the selected layout.

10. The method of claim 8 wherein personalizing the selected layout comprises uploading an image and inserting the image into the selected layout.

11. The method of claim 8 wherein associating the selected article comprises creating text describing the report.

12. The method of claim 8 further comprising printing the visual content onto a single medium.

13. The method of claim 8 further comprising associating the selected article and the selected report with one or more addresses.

14. The method of claim 8 further comprising storing the content and associating the content with a user.

15. A computer readable medium storing a program that, when executed by a processor of a computer, performs a method comprising:
selecting one of a plurality of layouts;
personalizing the selected layouts;
selecting one of a plurality of articles;
associating the selected article with the selected layout; and
automatically creating visual content containing the selected article and the selected layout.

16. The method of claim 15 wherein personalizing comprises selecting a color scheme and applying the color scheme to the selected layout.

17. The method of claim 15 wherein personalizing comprises uploading an image and inserting the image into the selected layout.

18. The method of claim 15 wherein associating comprises creating text describing the report.

19. The method of claim 15 further comprising printing the visual content onto a single medium.

20. The method of claim 15 further comprising associating the selected article and the selected report with one or more addresses.
